(19) United States
(12) Patent Application Publication
(10) Pub. No.: US 2019/0075829 A1
(43) Pub. Date: Mar. 14, 2019

(54) ANTI-INTOXICATION COMPOSITION AND PROCESS

(71) Applicants: David Creasey, Leland, NC (US); Jason Creasey, Conroe, TX (US)

(72) Inventors: David Creasey, Leland, NC (US); Jason Creasey, Conroe, TX (US)

(21) Appl. No.: 16/130,530

(22) Filed: Sep. 13, 2018

Related U.S. Application Data
(60) Provisional application No. 62/558,466, filed on Sep. 14, 2017.

(51) Int. Cl. A23L 29/00; A23L 29/30; A23L 33/125; A23L 33/16

(52) U.S. Cl. CPC A23L 29/015; A23L 29/30; A23L 33/125; A23L 33/16; A23V 2002/00; A23V 2250/1642; A23V 2200/15; A23V 2250/1562; A23V 2250/1588; A23V 2250/161; A23V 2200/334

(57) ABSTRACT

A process for making an anti-intoxication food supplement composition, said process comprising the steps of combining sulfuric acid with water, such that the volume ratio of sulfuric acid to distilled water lies in the range 1:1 to 1:5, and with a sulfate salt at a ratio of 10-40% volume, forming a first mixture, combining the first mixture in a vessel at a pressure above atmospheric pressure, allowing an exothermic reaction to heat up the mixture forming a reacted first mixture, cooling the reacted first mixture, adding a compound containing metal ions to the reacted first mixture, to form a second mixture, diluting the second mixture with water and adding at least one sweetener, flavoring agent, micro nutrient, macro nutrient, or food additive such as a vitamin to provide an anti-intoxication food supplement composition.

### CROSS REFERENCE TO RELATED APPLICATION

This application claims the priority of the provisional application Ser. No. 62/558,466 filed Sep. 14, 2017. Applicant hereby incorporates by reference the entire content of provisional application Ser. No. 62/558,466.

### FIELD OF INVENTION

The instant relates to a food supplement composition which can accelerate the natural metabolic pathway of alcohol in-vitro. The effects of excessive consumption of alcohol on the body system can thus be neutralized. This food supplement composition aids the natural metabolic pathway of the alcohol present after large consumption in-vitro.

### BACKGROUND OF THE INVENTION

The abuse of alcohol is associated with various health outcomes and concerns. The problem with large amounts of alcohol becomes a toxin. Regular over-consumption of alcohol destroys any positive effects and replaces them with all kinds of health problems, including the most immediate one; hangover, pounding headache, nausea, dry mouth, shaking hands, hypersensitivity to bright lights and sounds.

When alcohol enters the digestive tract, it encounters an enzyme called dehydrogenase that metabolizes it into acetaldehyde. When a moderate amount of alcohol is consumed, conversion of this aldehyde into harmless compounds takes place. However, when an excessive amount of alcohol is consumed, nutrients required for the conversion to amino acids are depleted and aldehyde stays in the body. One of the most damaging effects of aldehyde is a process called cross-linking, which binds up molecules and hinders normal function. Aldehyde is also a potent pro-oxidant that drains the body's store of antioxidants, B vitamins, and other vital nutrients. The results are dehydration, low blood sugar levels, nutrient deficiencies and cellular damage to vital organs, such as the liver.

It would be desirable to have a food supplement composition that promotes the in-vivo metabolism of alcohol-containing beverages and aids in the body's degradation of alcohol into harmless non-toxic substances.

Various compositions for treating alcoholism, reducing or preventing alcohol intoxication have been described in the literature.

Two US patent applications (US 2004/0086574 and US 2003/0012826—now U.S. Pat. No. 6,660,293 B2) to Giordano, describe a treatment for alcoholism using copper sulfate and a “cocktail” of various vitamins, preferably free of iron. US2002/0015741 to Bowen describes the use of additives such as transition metals (e.g., ammonium iron citrate, ammonium molybdate for accelerating in vivo oxidation of ethanol to acetic acid. U.S. Pat. No. 4,346,082 to Revici describes the use of inorganic sulfur compounds (i.e. ammonium sulfate solution with pH >5) for reducing or preventing alcohol intoxication. U.S. Pat. No. 4,582,705 to Primes describes a composition used to detoxify alcoholics which includes magnesium sulfate, copper ions, etc.

Herbal and natural remedies for treating alcohol hangovers and remedies to increase alcohol degradation within the body include enzymes and taurine as described in Fuchs U.S. Pat. No. 6,514,544, calcium compounds from seaweed as described by Auchincloss U.S. Pat. No. 6,346,275, herbal teas extracted from leaves, stems, roots or alder and mountain ash trees as described by Nam in U.S. Pat. No. 5,968,520; herbal or vegetable extracts containing naturally occurring daidzin and diadzein as described by Duthinh in U.S. Pat. No. 5,547,671 and capsicum pepper and bark or wood of the poplar tree as described by Fontaine in U.S. Pat. No. 4,931,277. A broad range of hangover remedies and antiintoxication compositions are indicative of the need to find a reliable solution to the problem. The instant invention provides an effective formulation to protect the body from excessive alcohol intake.

In U.S. Pat. Nos. 5,989,595 and 6,242,011 B1 to Cummins, an acidic composition of matter is disclosed that is useful for destroying microorganisms that spoil food, such as fish. The composition of matter, patented by Cummins, is also useful for skin treatment of melanoma and the treatment of other bacteria and serves as a precursor for the novel composition and method for promoting the metabolism of alcohol.

Thus, there is clearly a need for a food supplement composition which can accelerate the natural metabolic pathway of alcohol in-vitro and neutralize the effects of excessive consumption of alcohol on the body system. The instant invention is designed to provide that composition.

### SUMMARY OF THE INVENTION

In a first aspect, a process for making an anti-intoxication food supplement composition is provided. In a further embodiment, an anti-intoxication food supplement composition is provided, for use in treating alcoholism or reducing or preventing alcohol intoxication. In a further embodiment, a method for reducing or preventing alcohol intoxication is provided, said method comprising the step of administering the anti-intoxication food supplement composition described herein to an alcohol intoxicated patient. In a further embodiment, a method for treating alcoholism is provided, said method comprising the step of administering the anti-intoxication food supplement composition described herein to an alcoholic patient.

### DETAILED DESCRIPTION OF THE INVENTION

The instant invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The instant invention describes a food supplement composition for removing the toxic effects of excessive alcohol consummation by humans. The instant invention also describes a method of making the composition, and methods of use of such compositions. The composition is an acidic mixture containing sweeteners, flavorings, macro and micro nutrients, vitamins, metallic salts, reacted sulfuric acid with ammonium sulfate and high purity water. When the food supplement composition is ingested it promotes the natural metabolic pathway of alcohol, primary ethanol and methanol within the body. The beneficial results in the accelerated conversion of alcohol and eliminates or reduces the toxic effects and impact to the body of alcohol.

One objective of the instant invention is to provide a naturalizing effect of alcohol in the body after large intake of alcohol beverages. Another objective is to provide an ingestible composition that promotes metabolic conversion of alcohol to various COOH group acids (fatty acids, amino acids, keto acids, dicarboxylic acid, alpha hydroxy acids). A further objective is to provide a composition that ameliorates certain negative effect of excess alcohol intake. A further objective is to provide an easy-to-take dosage that changes the body alcohol content and provides excess macro and micro nutrients and vitamins to metabolically complete the alcohol degradation process. A further objective is to provide a composition that reduces the strain on human organs due to excessive alcohol intake. A further objective is to increase the alcohol degradation of an individual.

The instant invention discloses a process for making an anti-intoxication food supplement composition by first reacting a food grade sulfuric acid and ammonium sulfate solution to promote an exothermic reaction that removes free radicals. Free radicals refer to atoms, ions or molecules with an unpaired valence electron, generally making them highly reactive to other atoms, ions and/or molecules. The term “food supplement” is used to describe the instant composition, as it is a nutrient-containing composition which promotes or supports the body's natural mechanisms for alcohol metabolism, rather than having a pharmaceutical effect on the body.

In a first embodiment, therefore, a process for making an anti-intoxication food supplement composition is provided comprising the steps of:
a. combining an acid with water and a sulfate salt, forming a first mixture;
b. combining the first mixture in a vessel at a pressure above atmospheric pressure and allowing an exothermic reaction to heat up the mixture forming a reacted first mixture;
c. cooling the reacted first mixture;
d. adding a compound containing metal ions to the reacted first mixture, to form a second mixture;
e. diluting the second mixture with water; and
f. adding at least one sweetener, flavouring agent, micro nutrient, macro nutrient, or food additive to provide an anti-intoxication food supplement composition.

The first basic ingredient used is a strong, low pH acid such as, phosphoric acid, fumaric acid, nitric acid, sulfurous acid, sulfonic acid, perchloric acid, acetic acid, sulfuric acid or a combination thereof. Preferably, the acid is a food grade acid. The acid is of at least 90%, 91%, 92%, 93%, 94%, 95%, 96%, 97%, 98%, 99% or 99.9% purity. The acid may also be between approximately 98% to approximately 99.99% purity.

The next basic ingredient used is water selected from the group comprising: distilled water, deionized water, purified water, filtered water, pharmaceutical grade water, medical grade water, reverse osmosis water, or a combination thereof. The water preferably has a mega Ohm count between 5-19. The volume ratio of sulfuric acid to distilled water lies in the range of 1:1, 1:2, 1:3, 1:4 or 1:5.

The water or acid/water mixture is combined with a sulfate selected from the group including sodium sulfate, Ammonium sulfate, magnesium sulfate, zinc sulfate, manganese sulfate, copper sulfate, Barium Sulfate, Calcium Sulfate, Iron Sulfate, Potassium Sulfate, Nickel Sulfate, radium sulfate, Strontium Sulfate, dihyro-sulfate and silver Sulfate to form a solubilized sulfate. The water or acid/water mixture and a sulfate salt has a ratio of 10-40% volume, a ratio of 15-35% volume, a ratio of 20-30% volume, a ratio of 20-25% volume, or a ratio of 23-24% volume resulting in a first mixture.

A voltage may be applied to the mixture during the addition of sulfate solution. This can consist of a DC current in a range of 1 to 100 amps, 1 to 90 amps, 1 to 80 amps, 1 to 70 amps, 1 to 60 amps, 1 to 50 amps, 1 to 40 amps, 1 to 30 amps, 1 to 20 amps, 1 to 10 amps, preferably a range of 1 to 5 amps.

The first mixture is then combined within a reaction vessel at a pressure at or above atmospheric pressure, allowing an exothermic reaction to heat the mixture. The reaction vessel may be any vessel known in the art which can sustain the temperatures generated during the formation of the instant anti-intoxication food supplement composition such as a pressurized glass lined double wall vessel. The pressure within the vessel is maintained at a pressure of in a range between approximately 1 psi to approximately 20 psi above atmospheric pressure, between approximately 2 psi and 17 psi above atmospheric pressure, between approximately 5 psi and 13 psi above atmospheric pressure, or between approximately 8 psi and 11 psi above atmospheric pressure. Typically, the exothermic reaction which generates temperatures in the range of 90° C. to 430° C., 150° C. to 430° C., 200° C. to 370° C., 260° C. to 430° C., 315° C. to 430° C.

The mixture is then allowed to cool or is cooled, e.g. by means of indirect cooling, after which a compound containing food-grade metal ions is added to form a second mixture. The mixture is allowed to cool to a temperature in the range of 15° C. to 65° C., 18° C. to 65° C., 15° C. to 55° C., 15° C. to 45° C., 15° C. to 35° C., 15° C. to 25° C., or 15° C. to 20° C. within a time range of 15 to 60 minutes, 15 to 45 minutes, 15 to 30 minutes, or 30 to 60 minutes. In one embodiment of the instant invention, a cooling jacket surrounds the reaction vessel to aid in cooling the mixture. The coolant used in either the cooling jacket or the cooling system is an air coolant, a liquid coolant, a gas coolant, or a combination thereof. The liquid coolant is selected from the group including: water, ethylene glycol, diethylene glycol, propylene glycol, polyalkylene glycol, poly glycol, betaine, or a combination thereof. The gas coolant is selected from the group including: inert gas, hydrogen, nitrogen, carbon dioxide, or a combination thereof. The food-grade metal ions are selected from the group consisting of copper ions, silver ions, zinc ions, magnesium ions, nickel ions and mixtures thereof. The compound containing metal ions is selected from at least one of copper sulfate, copper sulfate pentahydrate, copper glutamate, zinc glutamate, magnesium glutamate, magnesium sulfate, and silver sulfate.

The second mixture is then diluted with water selected from the group comprising: distilled water, deionized water, purified water, filtered water, pharmaceutical grade water, medical grade water, reverse osmosis water, or a combination thereof. The water preferably has a mega Ohm count between 5-19. The ratio of water used to form a solution of compounds containing metallic ions to the total mixture is in the range between 0.2% and 75% by weight. In other embodiments, the ratio of water used to form a solution of compounds containing metallic ions to the total mixture is in the range of 0.5% and 70%, 1% and 70%, 0.2% and 10%, 5% and 70%, 10% and 70%, 20% and 75%, 30% and 75%, 40% and 75%, 45% and 75%, 50% and 75%, 55% and 75%, 60% and 75%, or 65% and 75%.

After dilution, at least one sweetener, flavoring agent, micro and macro nutrient, or food additive such as a vitamin, is added, resulting in an anti-intoxication composition. The sweetener may be selected from the group comprising polysaccharides, e.g. sucrose, fructose, glucose, dextrose, isomaltose, inulin, lactitol and trehalose; synthetic sugar substitutes and salts thereof, such as xylitol, cyclamate, acesulfame, sucralose, saccharin, alitame and aspartame; polyols, e.g. glycerol, mannitol sorbitol and vanillin, and mixtures thereof. The flavoring agent may be selected from the group comprising ginger and orange/citrus essence, lemon, strawberry, watermelon, cherry, orange, grape, both natural and synthetically prepared flavourings known by those in the art. The food additive may be selected from the group consisting of citric acid, ascorbic acid, sodium benzoate, potassium benzoate, vitamins B-6, B-12, taurine and mixtures thereof.

The process according to any one of the preceding claims, wherein the ratio of water used to form a solution of compounds containing metallic ions to the total mixture is in the range between 0.2% and 75% by weight. In other embodiments, the ratio of water used to form a solution of compounds containing metallic ions to the total mixture is in the range between 0.2% and 75% by weight, 0.2% and 65% by weight, 0.2% and 55% by weight, 0.2% and 45% by weight, 0.2% and 35% by weight, 0.2% and 25% by weight, 5% and 75% by weight, 10% and 75% by weight, 15% and 75% by weight, 20% and 75% by weight, 25% and 75% by weight, 35% and 75% by weight, 45% and 75% by weight, 55% and 75% by weight, 60% and 75% by weight, or 20% and 55% by weight.

In one embodiment, an anti-intoxication food supplement composition is provided which is made by the process described herein. The anti-intoxication food supplement composition suitably has a pH of less than 7. In another embodiment, the anti-intoxication food supplement composition has a pH of less than 6, 5, 4, 3, 2, or 1.

Particular anti-intoxication food supplement compositions of the invention comprise (amounts in % by weight):

| Component | Case # | Form | % |
|---|---|---|---|
| Ascorbic Acid | 89-65-6 | Powder | 1-2 |
| (vitamin C) | | | |
| Ginger-(Spice) | 84696-15-1 | liquid | .01-.05 |
| Extract | | | |
| Grape Seed Extract | 84929-27-1 | Powder | .5-1 |
| Citric Acid | 77-92-9 | Powder | .01-.03 |
| Fructose | 57-48-7 | Powder | .01-.02 |
| Potassium Benzoate | 582-25-2 | Powder | .01-.05 |
| Pyridoxine | 58-56-0 | Powder | .3-.5 |
| Hydrochloride (B-6) | | | |
| Shitake Mushroom | 37339-90-5 | Powder | .1-.5 |
| Extract | | | |
| Sodium Benzoate | 532-32-1 | Powder | .01-.03 |
| B 12 | 68-19-9 | Powder | .1-.2 |
| (Cyanocobalamin) | | | |
| Sorbitol | 50-70-4 | Liquid | 1-2 |
| Taurine | 107-35-7 | Powder | .02-.04 |
| Xylitol | 87-99-0 | Powder | 5-10 |
| Orange Flavoring | 95327-98-3 | Liquid | .2-.5 |
| Extract | | | |
| Copper Sulfate | 7758-98-7 | Powder | .2-.4 |
| Pentahydrate | | | |
| Ammonium Sulfate | 7783-20-2 | Powder | .5-1 |
| Sulfuric Acid | 7664-93-9 | Liquid | .01-.02 |
| DI Water | 7732-18-5 | Liquid | 91.02-81.66 |

An anti-intoxication food supplement composition can be made by the process defined above. In a further embodiment, an anti-intoxication food supplement composition is provided, for use in treating alcoholism or reducing or preventing alcohol intoxication.

In a further embodiment, a method for reducing or preventing alcohol intoxication is provided, said method comprising the step of administering the anti-intoxication food supplement composition described herein to an alcohol intoxicated patient.

In a further embodiment, a method for treating alcoholism is provided, said method comprising the step of administering the anti-intoxication food supplement composition described herein to an alcoholic patient.

Any method described herein may incorporate any design element contained within this application and any other document/application incorporated by reference herein. Any design element contained within this application may be incorporated into any embodiment contained within this application.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The instant invention may be embodied in other forms without departing from the spirit and the essential attributes thereof, and, accordingly, reference should be made to the appended claims, rather than to the foregoing specification, as indicating the scope of the invention. The invention illustratively discloses herein suitably may be practiced in the absence of any element which is not specifically disclosed herein.

I claim:

1. A process for making an anti-intoxication food supplement composition, said process comprising the steps of:
a. combining a food grade acid with water, such that the volume ratio of food grade acid:distilled water lies in the range 1:1 to 1:5, and with a sulfate salt at a ratio of 10-40% volume, forming a first mixture;
b. combining the first mixture in a vessel at a pressure above atmospheric pressure, allowing an exothermic reaction to heat up the mixture forming a reacted first mixture;
c. cooling the reacted first mixture;
d. adding a compound containing metal ions to the reacted first mixture, to form a second mixture;
e. diluting the second mixture with water; and
f. adding at least one sweetener, flavouring agent, micro nutrient, macro nutrient, or food additive such as a vitamin to provide an anti-intoxication food supplement composition.

2. The process according to claim 1, wherein the sulfate salt in step a. is ammonium sulfate.

3. The process according to claim 1, wherein the food grade acid is of approximately 90 to 99.99 percent purity.

4. The process according to claim 1, wherein the volume ratio of sulfuric acid:distilled water lies in the range 1:2 to 1:4.

5. The process according to claim 1, wherein the water and a sulfate salt has a ratio of 15-35% volume.

6. The process according to claim 1, wherein the metal ions are selected from the group consisting of copper ions, silver ions, zinc ions, magnesium ions, nickel ions and mixtures thereof.

7. The process according to claim 1, wherein the compound containing metal ions is selected from at least one of copper sulfate, copper sulfate pentahydrate, copper glutamate, zinc glutamate, magnesium glutamate, magnesium sulfate, and silver sulfate.

8. The process according to claim 1, wherein a voltage is applied to the mixture during addition of sulfate solution.

9. The process according to claim 1, wherein the sweetener is selected from the group comprising polysaccharides, synthetic sugar substitutes and salts thereof, polyols, and mixtures thereof.

10. The process according to claim 1, wherein the ratio of water used to form a solution of compounds containing metallic ions to the total mixture is in the range between 0.2% and 75% by weight.

11. The process according to claim 1, wherein the flavoring agent is selected from the group comprising ginger and orange/citrus essence, lemon, strawberry, watermelon, cherry, orange, grape, both natural and synthetically prepared flavourings.

12. The process according to claim 1, wherein the food additive is selected from the group consisting of citric acid, ascorbic acid, sodium benzoate, potassium benzoate, vitamins B-6, B-12, taurine and mixtures thereof.

13. An anti-intoxication food supplement composition made by the process according to claim 1.

14. The anti-intoxication food supplement composition according to claim 13, having a pH of less than 7.

15. The anti-intoxication food supplement composition according to claim 13 comprising at least one sweetener, flavoring agent, micro and macro nutrient, or food additive such as a vitamin.

16. The anti-intoxication food supplement composition according to claim 15 wherein the sweetener is selected from the group comprising polysaccharides, synthetic sugar substitutes and salts thereof, polyols, and mixtures thereof.

17. The anti-intoxication food supplement composition according to claim 15 wherein the flavoring agent is selected from the group comprising ginger and orange/citrus essence, lemon, strawberry, watermelon, cherry, orange, grape, both natural and synthetically prepared flavourings.

18. The anti-intoxication food supplement composition according to claim 15, wherein the food additive is selected from the group comprising citric acid, ascorbic acid, sodium benzoate, potassium benzoate, vitamins B-6, B-12, taurine and mixtures thereof.

19. The anti-intoxication food supplement composition according to claim 15, comprising a compound containing metal ions, the metal ions being selected from the group consisting of copper ions, silver ions, zinc ions, magnesium ions, nickel ions and mixtures thereof.

20. The anti-intoxication food supplement composition according to claim 19, wherein the compound containing metal ions is selected from at least one of copper sulfate, copper sulfate pentahydrate, copper glutamate, zinc glutamate, magnesium glutamate, magnesium sulfate, and silver sulfate.
